(19) United States
(12) Patent Application Publication
(10) Pub. No.: US 2020/0248039 A1
(43) Pub. Date: Aug. 6, 2020

(54) SELF-ADHESIVE PERMEABLE MEMBRANE AND METHOD FOR PRODUCING SUCH A SELF-ADHESIVE PERMEABLE MEMBRANE

(71) Applicants: Hervé Durand, Dijon (FR); Hervé Lluch, Chaux (FR); Maud Williams, Dijon (FR); Lilian Moussie, Dijon (FR)

(72) Inventors: Hervé Durand, Dijon (FR); Hervé Lluch, Chaux (FR); Maud Williams, Dijon (FR); Lilian Moussie, Dijon (FR)

(73) Assignee: ADHEX TECHNOLOGIES, Chenôve (FR)

(21) Appl. No.: 16/782,889

(22) Filed: Feb. 5, 2020

(30) Foreign Application Priority Data
Feb. 6, 2019 (FR) 1901194

(51) Int. Cl. C09J 9/00; C09J 7/38; C09J 133/04; C09J 7/25

(52) U.S. Cl. CPC C09J 9/00; C09J 7/385; C09J 133/04; C09J 2400/14; C09J 2433/00; C09J 2467/006; C09J 7/255

(57) ABSTRACT

The present invention concerns a self-adhesive water vapour-permeable membrane comprising at least one water vapour-permeable support and a pressure-sensitive, sensitive to pressure, water vapour-permeable, and integral with the lower face of said support. Said membrane is noteworthy in that it comprises a grid included totally or partially in the adhesive layer and in that it comprises air bubbles confined between the meshes of the grid which favour the penetration and the diffusion of the water vapour molecules. Another subject matter of the invention concerns a method for producing such a membrane.

### CROSS REFERENCE TO RELATED APPLICATION

This application claims priority under 35 U.S.C. § 119 to French Patent Application No. 1901194, filed Feb. 6, 2019, which is herein incorporated by reference in its entirety.

### TECHNICAL FIELD

The present invention concerns a self-adhesive and water vapour-permeable membrane and its production method. Such a membrane is, in particular, intended for the healthcare field for the production of dressings or similar, as well as for the building construction field, said membrane being intended to be applied on walls and/or sub-roofs to control water vapour flows.

### BACKGROUND

In the healthcare field, and more specifically in that of dressings, it is well known that said dressing must preferably be water vapour-permeable (exudates) in order to let the skin surrounding the wound to breathe to avoid any maceration. In addition, in the field of building construction, it is well known that humidity problems in walls are attributed to a main mechanism, namely the diffusion of water vapour. The diffusion of water vapour through the walls can lead to numerous disorders such as erosion of the masonry, freezing of pipes, condensation and accumulation of ice in cavities, humidification of insulation, making them ineffective and the growth of mould, in particular.

The uncontrolled movement of water vapour through the casing of the building is caused by pressure differences produced by wind. Air leakages can originate from cracks or faulty seals between construction elements and structural elements or through porous materials such as concrete blocks and porous insulation materials.

In order to limit these humidity problems, it is usual to use barrier films or vapour barriers, such as a polyethylene film, to control the movement of water vapour in the casing of the building. The vapour barrier film delays the diffusion of water through all of the materials in the walls, the speed at which water vapour migrates or diffuses through a material dependent on two factors: the difference between the water vapour pressure in the air inside the building, and the water vapour pressure in the air outside of the building and the resistance of the material present in the migration of water by diffusion. Vapour barrier films provide a greater resistance to the diffusion of water vapour than rather the other materials. Thus, polyethylene films of a sufficient thickness are more commonly used for this purpose; however, other materials such as aluminium paper or certain paints or adhesives have also been used as a vapour barrier.

However, these vapour barrier films are not sufficient and it is necessary to connect a barrier film to them in order to avoid the outside air from entering into the building. Indeed, the humidity-loaded air passing through a cavity insulated with a vapour barrier film can have a lot more humidity than the vapour barrier will be capable of diffusing in the same period of time.

Thus, water vapour-permeable vapour barrier films have been developed, such as products commercialised under the name Blueskin® by the American company Bakor® consisting in an air barrier, water vapour-permeable, water-resistant and self-adhesive membrane. These products correspond to the products described in American patent U.S. Pat. No. 6,901,712 filed by the company Bakor® which describes a water vapour-permeable air barrier film constituted of a water vapour-permeable sheet, obtained from polyethylene and modified polyolefins, on a surface of which an adhesive made of a non-continuous film is applied.

Although this type of vapour barrier film does not require any fixing means to fix said film on a wall or similar, the adhesive of these films is not water vapour-permeable such that this limits the water-permeability of the film only to the portions of the film not comprising any adhesive.

In order to overcome this disadvantage, vapour barrier films have already been imagined, comprising a continuous pressure-sensitive adhesive layer and water vapour-permeable. It is the case, in particular, of international patent application WO 2009/127819 which describes a self-adhesive permeable membrane sheet, intended to be used in a building structure, which comprises a continuous layer of a permeable pressure-sensitive adhesive, attached to a surface of a permeable membrane sheet. Said membrane sheet is constituted of a laminar structure comprising a spun-bonded polypropylene layer, a melt-blown type polyester layer, and a spun-bonded polypropylene layer and an adhesive layer, sensitive to base pressure comprising an air-permeability agent including a resin absorbing the water, glycol polypropylene and water, and a crosslinking agent. It will be noted, that according to the information from the state of the art, the pressure-sensitive adhesive layer does not comprise any air bubbles in order to avoid a delamination as it described, in particular, in documents EP0670277 and EP2108687, in particular.

Also, document US 2018/066427 is known, which describes a building protection membrane, comprising a polypropylene fabric sheet spun-bonded with a pressure-sensitive adhesive, and water vapour-permeable, integrated on the rear face of the membrane and a draining matrix fixed to the front surface of the membrane, the draining matrix comprising individual thermoplastic strands placed randomly to form a net and connected together by hot-melt gluing. The strands of the matrix thus form channels for draining water.

However, all these vapour barrier films present the disadvantage of being expensive to produce and present a permeance which degrades itself over time in particular. By permeance, is meant the ability of a membrane or of a surface to let water vapour pass through it.

There is therefore a need for a self-adhesive and water vapour-permeable membrane to produce vapour barrier films or dressings, in particular of a simple and inexpensive design providing a good, constant permeance over time in particular.

### SUMMARY

One of the aims of the invention is therefore to overcome at least one of these disadvantages by proposing a self-adhesive and water vapour-permeable membrane to produce vapour barrier films or dressings, in particular of a simple and inexpensive design, and providing a good, constant permeance over time in particular.

To this end and according to the invention, a self-adhesive water vapour-permeable membrane is proposed, comprising at least one water vapour-permeable support and a pressure-sensitive adhesive layer, water vapour-permeable, and integral with the lower face of said support; said membrane is noteworthy in that it comprises a grid included partially or totally in the adhesive layer and in that it comprises air bubbles confined between the meshes of the grid which favour the penetration and the diffusion of water vapour molecules.

According to an embodiment, the adhesive layer presents a thickness, greater than or equal to the thickness of the grid.

Preferably, the grid presents a thickness comprised between 30 μm and 150 μm.

Moreover, the grid presents a stringed and weaved construction less than or equal to 10 strands/cm and less than 10 strands/cm, respectively.

In addition, the weave and string strands of the grid respectively presents a dtex comprised between 10 and 400.

The weave strands and the string strands of the grid are obtained in a thermoplastic polymer.

Said weave strands and the string strands of the grid are obtained in polyethylene terephthalate (PET) and/or polypropylene (PP) and/or polyamide (PA).

Alternatively, the weave strands and the string strands of the grid are obtained in glass fibres.

Accessorily, the glass fibres of the weave strands and of the string strands are impregnated by at least one thermoplastic polymer.

Said thermoplastic polymer is chosen from among the following list: ethylene vinyl acetate (EVA) and/or polyvinyl chloride (PVC) and/or polyvinyl alcohol (PVAL) and/or polyvinyl acetate (PVAC).

Another aim of the invention concerns a method for producing a self-adhesive, water vapour-permeable membrane comprising at least one water vapour-permeable support and a pressure-sensitive adhesive layer, water vapour-permeable, and integral with the lower face of said support; said method is noteworthy in that it comprises at least following steps of:

coating of a pressure-sensitive adhesive layer, on a non-stock protective film, said pressure-sensitive adhesive layer being water vapour-permeable;

hardening of said pressure-sensitive adhesive layer;

depositing of a grid on said hardened pressure-sensitive adhesive layer; and

lamination of the hardened pressure-sensitive adhesive layer, and of the grid on a water vapour-permeable support.

According to a first embodiment variant, the pressure-sensitive adhesive layer is obtained in an acrylic pressure-sensitive adhesive with solvent.

In this embodiment variant, the step of hardening said pressure-sensitive adhesive layer consists in a step of drying said adhesive layer.

According to a second embodiment variant, the pressure-sensitive adhesive layer is obtained in a pressure-sensitive adhesive of the crosslinkable acrylic hot-melt type.

In this second embodiment variant, the step of hardening of said pressure-sensitive adhesive layer consists in a step of crosslinking said adhesive layer.

Said crosslinking step consists, preferably, in a crosslinking by UV irradiation.

### DESCRIPTION OF THE DRAWINGS

Other advantages and features will best emerge from the following description of several embodiment variants, given as non-limiting examples, of the self-adhesive water vapour-permeable membrane, and of its production method according to the invention, in reference to the appended drawings, wherein:

FIG. 1 is a cross-sectional, schematic view of the self-adhesive water vapour-permeable membrane, according to the invention,

FIG. 2 is a top view of a grid of the self-adhesive water vapour-permeable membrane, according to the invention,

FIGS. 3a to 3e are cross-sectional, schematic view of different steps of the method for producing the self-adhesive water vapour-permeable membrane, according to the invention.

### DETAILED DESCRIPTION

For reasons of clarity, below in the description, the same elements have been designated by the same references in the different figures. In addition, the various views are not necessarily drawn to scale.

Below, a self-adhesive water vapour-permeable membrane will be described, intended for the production of a building vapour barrier film; however, it is obvious that said self-adhesive water vapour-permeable membrane according to the invention can be used for any other application, in particular to produce dressings, without moving away from the scope of the invention.

In reference to FIG. 1, the self-adhesive water vapour-permeable membrane according to the invention comprises at least one water vapour-permeable support 1, a pressure-sensitive adhesive layer 2, sensitive to pressure, water vapour-permeable, and integral with the lower face of said support 1, a grid 3 included in the adhesive layer 2, whose thickness is greater than or equal to the thickness of the grid 3, air bubbles being advantageously confined between the meshes of the grid 3 thus favouring the penetration and the diffusion of the water vapour molecules, and a non-stick protective film 4.

It will be observed, that for some applications, in particular in the healthcare field, the adhesive layer 2 can present a thickness less than the thickness of the grid 3 without moving away from the scope of the invention.

Said support 1 consists, for example, in a microperforated polyethylene (PE) film, a microperforated polypropylene (PP) film, a microperforated polyethylene (PE)/polypropylene (PP) copolymer film, a loaded and stretched polyethylene (PE) film, a loaded and stretched polypropylene (PP) film, a loaded and stretched polyethylene (PE)/polypropylene (PP) copolymer film, a polyether-based extruded polyurethane (TPU) thermoplastic film, a polyurethane- and polyether-block amide-based breathable thermoplastic film, a polyamide 6-6 (PA 6-6) film, or a combination of said films.

Alternatively, said support is a synthetic fibre-based non-woven support chosen from among polyethylene (PE), polypropylene (PP), polyethylene terephthalate (PET) and polyamide (PA) or a combination of these.

According to another embodiment variant, said support can consist in a laminar film comprising at least two woven or non-woven films such as described above.

The adhesive layer 2 consists in a hot-melt acrylic adhesive crosslinked via UV and tackified and presents a surface mass comprised between 30 and 160 g/m² and, preferably, a surface mass of 130 g/m². This adhesive layer 2 presents a thickness, less than or equal to 200 μm, and preferably, a thickness of 130 μm. Said adhesive layer 2 is obtained in a pressure-sensitive adhesive, preferably polar, and preferably crosslinked. Moreover, said adhesive is preferably acrylic-based. For example, said adhesive can consist in a solvent-phase self-crosslinking acrylic adhesive commercialised by the company Henkel corporation under the reference LOCTITE DURO-TAK 222A, LOCTITE DURO-TAK 1847, LOCTITE DURO-TAK 737, LOCTITE DURO-TAK 3954, DUROTAK 380-1053, or by the company AV Chemie under the reference Polytex SP 2085.

More specifically, said adhesive can consist in an acrylate copolymer-based (acrylic ester-based carboxyl copolymer) solvent phase self-crosslinking acrylic adhesive obtained by polymerisation of acrylic monomers, such as: methyl acrylate, ethyl acrylate, 2-ethylhexyl acrylate, n-butyl acrylate, 2-hydroxyethyl acrylate, or similar. The crosslinking can be obtained by adding any crosslinking agent, well-known to a person skilled in the art, such as a metal chelate or aluminium acetylacetonate=tris (2,4-pentanedionato-O,O′), for example.

It will be observed that the viscosity and the rheological behaviour of the adhesive can easily be adjusted by aromatic and aliphatic hydrocarbon solvent systems, such as alcohol solvents (methanol, ethanol, propanol 2), ketonic solvents (acetone, methylethylketone, pentane-2,4 dione), aromatic solvents (toluene), cyclic aliphatic solvents (cyclohexane, methylcyclohexane), aliphatic solvents (hexane and isomers, n-heptane, octane and isomers), in order to obtain a Brookfield viscosity comprised between 1000 mPa·s and 50000 mPa·s (LVT 3/12 rpm).

Preferably, said adhesive is a hot-melt acrylic adhesive crosslinked by UV, commercialised by the company Basf under the product line Ac Resin®, tackified or not with hydrogenated resin ester-type tackifying resins (reference Hydrogral G commercialised by the company DRT) or hydrocarbon resins such as resins commercialised by the company Eastman under the reference Kristalex F85.

It will be noted that all these adhesives are water vapour-permeable. In particular, the adhesive Ac Resin® A 250 UV presents a water vapour-permeability of 949 g/m²/24 h.

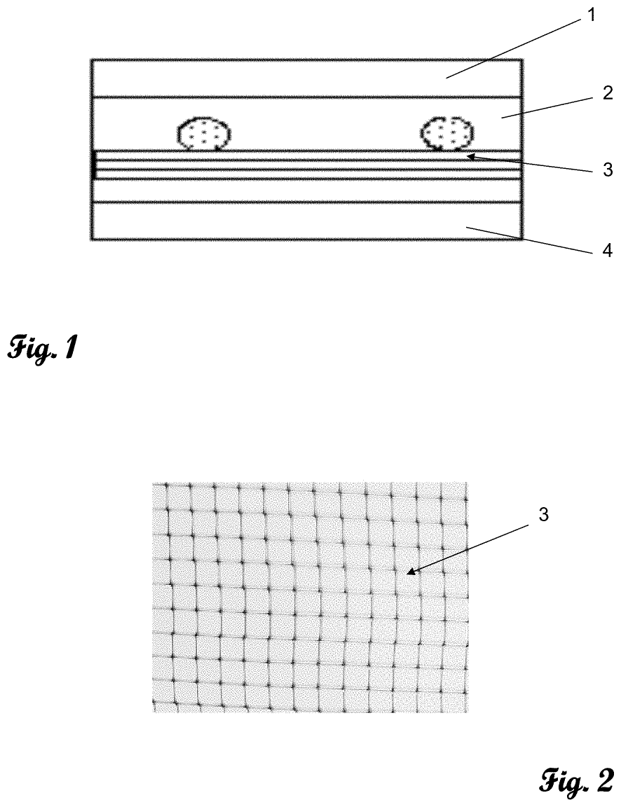

Moreover, in reference to FIGS. 1 and 2, the grid 3 presents a thickness comprised between 30 μm and 150 μm, as well as a mesh comprised between 1×1 and 10×10 mm. The weave strands and the string strands of the grid 3 are obtained in a thermoplastic polymer such as polyethylene terephthalate (PET) and/or polypropylene (PP) and/or polyamide (PA), the weave strands preferably presenting a dtex comprised between 10 and 400 and the string strands preferably presenting a dtex comprised between 10 and 400. Alternatively, the weave strands and the string strands of the grid are obtained in glass fibres which can advantageously be impregnated by at least one thermoplastic polymer such as ethylene vinyl acetate (EVA) and/or polyvinyl chloride (PVC) and/or polyvinyl alcohol (PVAL) and/or polyvinyl acetate (PVAC). The nature of the treatment on the surface of the strands can influence the chemical compatibility of the grid 3 with adhesives, as well as with tackifying agent.

It will be observed that, by design, a grid is constructed as an assembly of string strands (longitudinal direction) glued on/under weave strands (transversal direction). In order to reduce the total thickness of the grid, this connection is only generally achieved on one single side of the mesh. The resulting overlappings constitute many junction points, creating specific protrusions in relief on one single side. Indeed, a support grid contrary to a support film or a non-woven support, presents a different morphology between its front view and its hidden face. The junction points have a thickness at least equal to the sum of the thicknesses of a weave strand and an adjacent string strand, increased from the layer of glue bonding the weave strand with the adjacent string strand (several tens of μm). In addition, the strands of a grid being relatively flexible, they are not really aligned, not equidistant. A grid can therefore be defined as a heterogenous and anisotropic flexible support. Its features depend on its orientation (longitudinal direction or transversal direction) and of the face in question (front face or hidden face).

The table below summarises the features of thin and conformable reinforcing grids of the membrane, according to the invention. Their thickness is less than 150 μm. Their string and weave construction is respectively less than 10 strands/cm and less than 10 strands/cm.

| | Resistance to | Elongation to | |
|---|---|---|---|
| Chemical | breaking | breaking | |
| composition | (N/cm) | (%) | Impregnation |
| PE | <10 | >40 | EVA |
| PP - Copo | | | |
| PP | | | |
| PA | <20 | >20 | EVA, PVAc, |
| PET | | | PVC, PVOH |
| Glass fibre | >100 | ≤4 | PVOH, EVA, |
| | | | PVAc |

For the application of a vapour barrier membrane in the construction field, a glass fibre grid 3 is preferred.

An example for an application in the construction field comprises:
a glass fibre textile grid commercialised by the company Porcher Industries under the reference D4208C058 having a thickness of 90 μm and an impregnation of PVAc;
an Ac Resin 250 UV adhesive, thickness 130 μm, UV dose of 130 mJ/cm²to be crosslinked;
a non-woven PEHD support commercialised by the company Dupont de Nemours under the reference Tyvek 1058D.

For the application to a medical device or to one of its components in the healthcare field, a polyester grid 3 is preferred.

An example for an application in the healthcare field comprises:
a PET grid commercialised under the company DYLCO under the reference 92183 presenting a thickness of 95 μm and a string construction of 7.2 strands/cm and a weave construction of 3.5 strands/cm;
a solvent phase self-crosslinking acrylic adhesive commercialised by the company Henkel Corporation under the reference LOCTITE DURO-TAK 737: thickness 50 μm;
a non-woven PET support commercialised by the company Freudenberg under the reference Viledon M1535 presenting a surface grammage of 60 g/m².

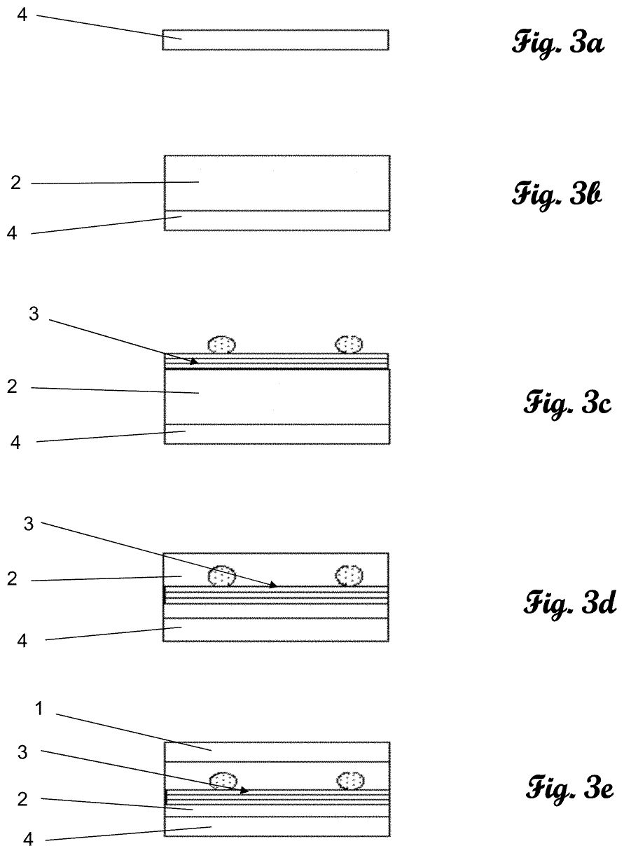

The method for producing the self-adhesive water vapour-permeable membrane according to the invention will now be explained, in reference to FIGS. 3a to 3e.

Said method consists, from a non-stock protective film 4 (FIG. 3a), of coating said non-stick protective film 4 of a pressure-sensitive adhesive layer 2, said pressure-sensitive adhesive layer 2 being water vapour-permeable, in reference to FIG. 3b. Then, the method comprises a step of hardening said hardened pressure-sensitive adhesive layer (FIG. 3b) before a step of deposit (FIG. 3c) of grid 3 on said hardened pressure-sensitive adhesive layer. Said grid partially or totally penetrates into the hardened pressure-sensitive adhesive layer 2 (FIG. 3d). Then, the method comprises a step of laminating (FIG. 3e) the hardened pressure-sensitive adhesive layer 2 and the grid 3 on a water vapour-permeable support 1.

For example, in the laminating phase of the transfer coating method, a person skilled in the art will preferably choose a laminating pressure on the pressure cylinder of less than 5 bars and/or a temperature of the pressure cylinder of less than 10° C., the pressure cylinder comprising a rubber coating or similar, preferably presenting a hardness less than or equal to 80 Shore A, to avoid pushing out the air and making it possible for the formation of air bubbles confined between the meshes of the grid.

However, it is obvious that a person skilled in the art can easily adapt the parameters, at the pressure and at the temperature of the lamination, in particular according to the composition of the adhesive layer and of the grid without moving away from the scope of the invention.

According to a first embodiment variant, the pressure-sensitive adhesive layer is obtained in an acrylic pressure-sensitive adhesive with solvent.

In this embodiment variant, the step of hardening said pressure-sensitive adhesive layer consists in a step of drying said adhesive layer. This drying step consists in the passage of the adhesive layer, at the outlet of the coating tunnel, through several drying boxes whose temperatures vary from 70° C. to 140° C. in order to evaporate the solvents, the solvent ratio needing to be less than 1%, and preferably less than 0.5%.

According to a second embodiment variant, the pressure-sensitive adhesive layer is obtained in a pressure-sensitive adhesive, of the crosslinkable acrylic hot-melt type.

In this second embodiment variant, the step of hardening said pressure-sensitive adhesive layer consists in a step of crosslinking said adhesive layer. For example, the crosslinking is achieved by UV irradiation. For an Ac resin 250 UV adhesive layer such as described above, the crosslinking is achieved by UV irradiation by means of a mercury bulb UV lamp delivering a UVC dose of 50 mJ/cm² for an adhesive thickness of 50 μm and of 130 m/cm² for an adhesive thickness of 130 μm.

Finally, it is obvious that the examples which have just been given are only particular illustrations, in no case limiting, regarding the fields of application of the invention.

The embodiments of the invention in which an exclusive property or privilege is claimed are defined as follows:

1. A self-adhesive water vapour-permeable membrane comprising at least one water vapour-permeable support and a pressure-sensitive adhesive layer, water vapour-permeable, and integral with the lower face of said support,
wherein it comprises a grid included partially or totally in the adhesive layer and in that it comprises air bubbles confined between the meshes of the grid which favour the penetration and the diffusion of the water vapour molecules.

2. The membrane according to claim 1, wherein the adhesive layer presents a thickness greater than or equal to the thickness of the grid.

3. The membrane according to claim 1, wherein the grid presents a thickness comprised between 30 μm and 150 μm.

4. The membrane according to claim 1, wherein the grid presents a string and weave construction less than or equal to 10 strands/cm and less than 10 strands/cm, respectively.

5. The membrane according to claim 1, wherein the weave and string strands of the grid respectively present a dtex comprised between 10 and 400.

6. The membrane according to claim 1, wherein the weave strands and the string strands of the grid are obtained in a thermoplastic polymer.

7. The membrane according to claim 6, wherein the weave strands and the string strands of the grid are obtained in polyethylene terephthalate (PET) and/or polypropylene (PP) and/or polyamide (PA).

8. The membrane according to claim 1, wherein the weave strands and the string strands of the grid are obtained in glass fibres.

9. The membrane according to claim 8, wherein the glass fibres of the weave strands and the string strands are impregnated by at least one thermoplastic polymer.

10. The membrane according to claim 9, wherein said thermoplastic polymer is chosen from among the following list: ethylene vinyl acetate (EVA) and/or polyvinyl chloride (PVC) and/or polyvinyl alcohol (PVAL) and/or polyvinyl acetate (PVAC).

11. A method for producing a self-adhesive water vapour-permeable membrane according to claim 1, wherein it comprises at least the following steps of:
coating a pressure-sensitive adhesive layer on a non-stick protective film, said pressure-sensitive adhesive layer being water vapour-permeable;
hardening of said pressure-sensitive adhesive layer;
depositing of a grid on said hardened pressure-sensitive adhesive layer; and
laminating the hardened pressure-sensitive adhesive layer and the grid on a water vapour-permeable support.

12. The method according to claim 11, wherein the pressure-sensitive adhesive layer is obtained in an acrylic pressure-sensitive adhesive with solvent.

13. The method according to claim 11, wherein the step of hardening said pressure-sensitive adhesive layer consists in a step of drying said adhesive layer.

14. The method according to claim 11, wherein the pressure-sensitive adhesive layer sensitive to pressure, is obtained in a pressure-sensitive adhesive, of the crosslinkable acrylic hot-melt-type.

15. The method according to claim 11, wherein the step of hardening said pressure-sensitive adhesive layer, consists in a step of crosslinking said adhesive layer.

16. The method according to claim 15, wherein the crosslinking step consists in a crosslinking via UV irradiation.
